(19) United States
(12) Patent Application Publication
(10) Pub. No.: US 2018/0137536 A1
(43) Pub. Date: May 17, 2018

(54) Marketing Campaign Selection Using Local Environmental Sensors

(71) Applicant: Adobe Systems Incorporated, San Jose, CA (US)

(72) Inventors: Carsten Ziegeler, Paderborn (DE); Allaert Joachim David Bosschaert, Balbriggan (IE)

(73) Assignee: Adobe Systems Incorporated, San Jose, CA (US)

(21) Appl. No.: 15/351,223

(22) Filed: Nov. 14, 2016

(51) Int. Cl. G06Q 30/02

(52) U.S. Cl. CPC G06Q 30/0261; G06Q 30/0252

(57) ABSTRACT

Marketing campaign selection using local environmental sensors is described. In one or more implementations, sensor data is received from an environmental sensor disposed proximal to a physical store describing a physical environment of the store. A marketing campaign is selected and sent for exposure to customers of the store based on the received sensor data.

### BACKGROUND

Purveyors of products and services that rely on physical stores have long struggled with how to effectively market their products and services to customers in order to generate revenue. Often times, marketing campaigns such as advertisements with discounts and sales on certain products are used by the purveyors to attract customers to their physical stores. For example, an advertisement may be placed in a storefront for exposure to customers that may walk or drive by the store. Traditional methods of selecting such marketing campaigns are often based on historical factors that fail to account for current conditions in or around the store that may influence customer behavior. Because current conditions in or around the store are constantly changing, so too are desires and attitudes of customers. Thus, traditional marketing campaign selection techniques are slow to adapt to current conditions in or around a store.

Accordingly, conventional techniques used by purveyors of products and services by way of physical stores to choose marketing campaigns may not be optimized for rapidly changing desires of potential customers due to changing conditions in or around the store.

### SUMMARY

Marketing campaign selection is described that is based, at least in part, on detection of a physical environment using local environmental sensors. In one or more implementations, a digital medium environment includes at least one computing device that is configured to select a marketing campaign for a physical store based on a physical environment of the store. A marketing campaign is any digital marketing activity such as an email, a notification to an application, an advertisement on a webpage, a display on a billboard, marquee, or store-front, and so on. An environmental sensor is any sensor capable of determining any environmental condition of the physical store. For example, an environmental sensor can be a weather sensor or a population monitoring device that can determine weather conditions or a number of people in/around the store, respectively.

In order to select the marketing campaign, an environmental condition of a physical environment of the store is detected by the sensors (e.g., weather conditions, number of people in the store, etc.) and communicated through a network (e.g., locally at the store and/or remotely over the Internet) to a campaign selection system. The campaign selection system is configured to select a marketing campaign based on the detected environmental condition of the physical environment of the physical store. For example, if the weather is nice (e.g., warm and not-raining) outside a more attractive marketing campaign (higher discount) may be provided than if the weather was poor, e.g., cold and raining. Accordingly, if environmental conditions of the physical environment around the store change, i.e. weather gets worse, the campaign selection system may select marketing campaign for exposure to customers that is less likely to draw users to the physical store, such as to decrease an available discount for goods or services. In another example, selection of the marketing campaign may follow particular environmental conditions, such as to advertise availability of rain gear during a rainstorm. The selected marketing campaign is then output for exposure to the customers. For example, the selected marketing campaign may be displayed in a store-front window of the store using a display device or sent to customers of the store via an email. By addressing environmental conditions of the physical store, a purveyor of products and services by way of the physical store may increase effectiveness of marketing campaigns offered for respective environmental conditions.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of a digital medium environment in an example implementation that is operable to select marketing campaigns based on local environmental sensors.

FIG. 2 is an illustration of an example digital medium implementation illustrating the example environment of FIG. 1 disposed at least in part in a store.

FIG. 3 is an illustration of an example implementation illustrating two example environments of a store and respective selected marketing campaigns.

FIG. 4 is an illustration of an example implementation illustrating two example environments of a store and respective selected marketing campaigns.

FIG. 5 is a flow diagram depicting a procedure in an example implementation to select a marketing campaign based on an environment around a store.

FIG. 6 is an illustration of a system and device in an example implementation that is operable to select marketing campaigns based on local environmental sensors.

### DETAILED DESCRIPTION

Overview

Techniques and systems are described that receive data from at least one environmental sensor disposed proximal to or within a physical store and select a marketing campaign based on the received sensor data. The selected marketing campaign is then output for exposure to potential customers of the physical store. For example, a weather sensor disposed locally to a physical store may be utilized to choose a marketing campaign (hereinafter “campaign”) for exposure to customers based on weather conditions around the physical store. As one example, a marketing campaign to advertise availability of warm weather boots may be chosen in response to a drop in temperature.

To begin, at least one sensor is disposed within or proximal to a physical environment of a physical store (hereinafter “store”). The store may be any type of business that exists in the physical world that has customers visit a physical location of the store, i.e., not online only. Physical stores are sometimes referred to as “brick and mortar” stores. Examples of physical stores are shops, department stores, superstores, outlet stores, spaces in malls, and so on. Examples of sensors are temperature sensors, rain sensors, population monitoring devices, and so on. The sensor may have any number of communication capabilities that enable the sensor to communicate with other devices. Examples of communication capabilities are Bluetooth®, Wi-Fi (i.e., one or more standards in accordance with IEEE 802.11), cellular data networks (e.g., LTE), LAN, WAN, Ethernet, fiber-optic, and any other wireless or wired communication mechanisms/protocols. Often times, these types of sensors are categorized under “Internet of Things” or IoT or “smart” devices due to their abilities to communicate over networks.

The sensor communicates data indicative of environmental conditions of a physical environment around or in the store to a campaign selection system. For example, the sensor may communicate a temperature reading outside the store to the campaign selection system. The campaign selection system receives the sensor data and, from this, selects an appropriate campaign. For example, if a temperature outside of the store is warm, a campaign with a percentage discount may be chosen to draw customers that otherwise would stay home due to this nice weather. On the other hand, if the temperature outside of the store is cold, another campaign with a lower percentage discount than the marketing campaign associated with the warm temperature may be chosen due to an increased likelihood of customers being “out and about.”

The selected campaign is then exposed to customers of the store. The selected campaign may be exposed through use of a monitor in the store front and/or elsewhere in the store, a billboard, a banner on a website, a notification to an application on a computing device, an email, and so on. For example, the selected marketing campaign may include graphical material to be sent to and displayed on a monitor in a store-front window for exposure to anyone passing by the store. Another example could be a banner ad relating to the selected marketing campaign that is posted on the store's website. In this way, the campaign selection system may quickly adapt to changes in environmental conditions of a physical environment of the physical store, which is not possible using conventional techniques. Further discussion of these and other examples is included in the following sections.

An example environment is described that may employ the campaign selection techniques described herein. Example procedures are then described which may be performed in the example environment as well as other environments. Consequently, performance of the example procedures is not limited to the example environment and the example environment is not limited to performance of the example procedures.

Terms

The terms “physical store” or “store” refer to any “brick and mortar” retail establishment that exists in the physical world that has customers visit the location of the store, i.e., not online only. Although the store is not online only, it may still have a website associated with the store. Examples of stores are shops, department stores, superstores, outlet stores, spaces in malls, and so on.

The terms “marketing campaign” or “campaign” refer to any digital or non-digital marketing activity. Examples of campaigns are percentage discounts on product or service categories, discounts on particular products or services, store wide sales and discounts, availability of seasonal or other products or services that are not always available at the store, and so on.

The terms “environmental sensor” or “sensor” refer to any sensor able to detect and communicate characteristics of a physical environment associated with the store, e.g., inside or outside the physical store. The sensor may also be within a vicinity of the store, for example, proximal to a freeway or intersection near the store. Examples of sensors are rain sensors, wind sensors, temperature sensors, pressure sensors, light sensors, motion sensors, RFID sensors, population monitoring devices, traffic sensors, and so on.

The term “campaign selection system” refers to a computing system capable of selecting a campaign for exposure to customers of the store based on data received from the sensor. The campaign selection system may be implemented on site, e.g. implemented on a computing device within the store, or remote, e.g. over the cloud or at some other remote network location. An example of a campaign selection system is Adobe Experience Manager®.

The term “campaign display system” refers to a computing system capable of exposing a selected campaign to customers of the store. Examples of campaign display systems are electronic billboards, electronic marquees, computer monitors, television screens, audio transmission device, and so on.

The term “campaign communication module” refers to functionality implemented at least partially in hardware to communicate a selected campaign to a campaign display system, e.g., a monitor in a store-front, and/or to customers located away from the store, e.g., via email, website banner, notification from an application on an electric device, television ads, radio ads, podcast ads, streaming media ads, social media ads, and so on.

Example Environment

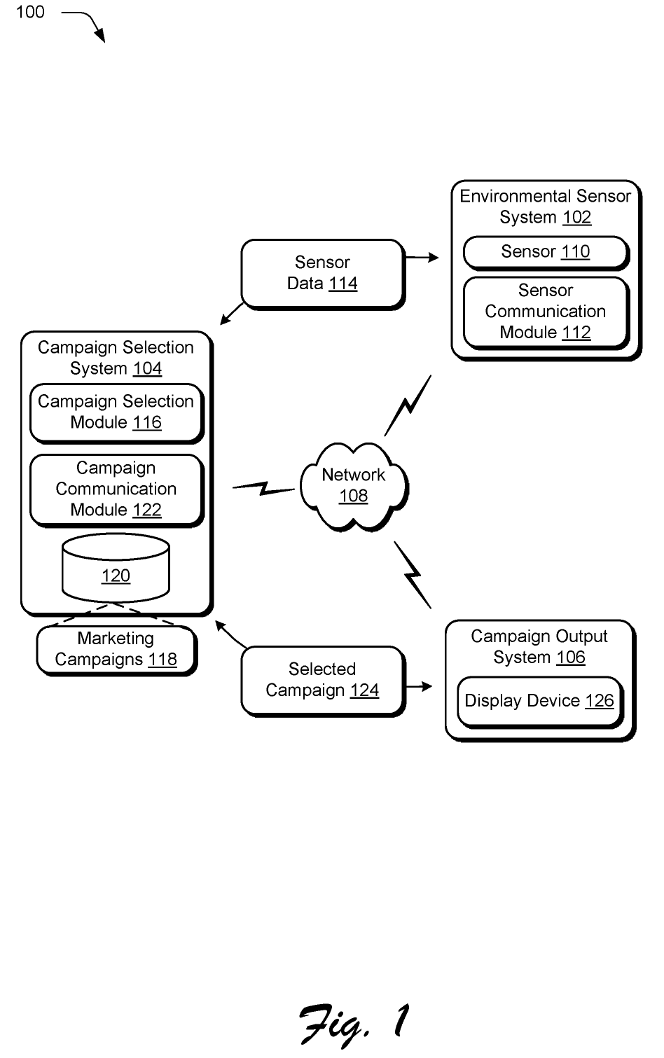

FIG. 1 depicts a digital medium environment, generally at 100, in an example implementation that is operable to enable marketing campaign selection using local environmental sensors. The illustrated digital medium environment 100 includes an environmental sensor system 102, a campaign selection system 104, and a campaign output system 106. The environmental sensor system 102, the campaign selection system 104, and the campaign output system 106 are communicatively coupled, one to another, via a network 108, e.g., the Internet, a Wi-Fi network (e.g., in accordance with one or more IEEE 802.11 standards), a wireless network, cellular data network, and so forth.

The environmental sensor system 102 is a sensor system of at least one sensor disposed proximal to or inside of a physical store used to detect an environmental condition of a physical environment of a store. Although the environmental sensor system 102 is described as within or proximal to the store, it may also be disposed in a vicinity of the store, for example, a traffic sensor near a freeway exit for the store. The environmental sensor system 102 includes a sensor 110 that may be configured in a variety of ways. Examples types of sensors 110 include temperature sensors, rain sensors, light sensors, pressure sensors, population monitoring devices, traffic sensors, and so on. The environmental sensor system 102 also includes a sensor communication module 112 that is implemented at least partially in hardware to communicate data from sensor 110, shown as sensor data 114, to campaign selection system 104. For example, the environmental sensor system 102 may send sensor data 114 describing a temperature outside of the store to the campaign selection system 104. Sensor data 114 may be sent to campaign selection system 104 directly through the sensor communication module 112 or through an intermediate gateway between the environmental sensor system 102 and the campaign selection system 104.

The sensor data 114 is then received by a campaign selection module 116 of the campaign selection system 104. The campaign selection system 104 may be part of any sort of marketing campaign management tool such as Adobe Experience Manager® or AEM®. The campaign selection module 116 is implemented at least partially in hardware of a computing device to select a marketing campaign for exposure to customers based on sensor data 114 received from the environmental sensor system 102. In the illustrated example, the campaign selection module 116 utilizes the received sensor data 114 from environmental sensor system 102 to select an appropriate marketing campaign from a group of potential marketing campaigns 118 stored in storage 120 based on a detected environmental condition of a physical environment of the store. The campaign selection system 104 may detect the environmental condition of the store from raw data received from the environmental sensor system 102, e.g., raw output values that are then processed to detect the environmental condition. In another example, the sensor data 114 received by the campaign selection system 104 is already processed by the environmental sensor system 102 to indicate the detected environmental condition.

Regardless of the form of the sensor data 114, the campaign selection system 104, and more particularly the campaign selection module 116, selects a marketing campaign 118 based at least in part of the sensor data 114. For example, if environmental sensor system 102 sends sensor data 114 that is indicative of rain proximal to the store, the campaign selection module 116 may select a marketing campaign associated with umbrellas from the marketing campaigns 118. As another example, if environmental sensor system 102 sends sensor data 114 that is indicative of traffic near a freeway off-ramp or intersection near the store, the campaign selection module 116 may select a marketing campaign associated with enticing drivers to avoid traffic and shop at the store. The campaign selection system 104 also contains a campaign communication module 122 that is implemented at least partially in hardware to communicate the selected campaign, shown as selected campaign 124, to the campaign output system 106.

The campaign output system 106 is a display system configured to expose the selected campaign 124 received from the campaign communication module 122 of campaign selection system 104 to potential customers. Campaign output system 106 may take a variety of forms. In one example, the campaign output system 106 includes a display device 126 to display the selected campaign 124. The display device 126 may be a television, a computer monitor, a touch screen, a kiosk screen, a billboard, an electronic mall banner, a website banner, and so on. Although the campaign output system 106 is discussed in terms of a visual display, the campaign output system 106 may also include an audio device such as a speaker that is able to output the selected campaign 124 through audio, alone or in combination with a visual output. The campaign output system 106 may be implemented as part of a computing device, or may be implemented as a standalone device, e.g., a traditional television with minimal processing capabilities. If the campaign output system 106 is implemented as part of a computing device, the campaign output system 106 may include a processing system that is able to execute instructions to output the selected campaign 124.

Although the selected campaign 124 is shown as being sent to the campaign output system 106 for exposure to customers, the selected campaign 124 may also be sent by the campaign communication module 122 for exposure to customers without the campaign output system 106. For example, campaign communication module 122 may send an email or application notification containing the selected campaign 124 to customers. Campaign communication module 122 may also send the selected campaign 124 for placement on the store's website or another website. For example, if environmental sensor system 102 sends sensor data 114 that is indicative of a heavy thunderstorm in the vicinity of the store, the campaign selection module 116 may select a campaign for placement on the store's website because customers are unlikely to visit the physical store during a strong weather event. Thus, the selected campaign 124 may be exposed to customers in conjunction with, or separately from, campaign output system 106. In another example, the campaign selection system 104 may send the selected campaign 124 to a retailer who then can decide how to expose the selected campaign 124 to customers (i.e. email, send to campaign output system 106, etc.).

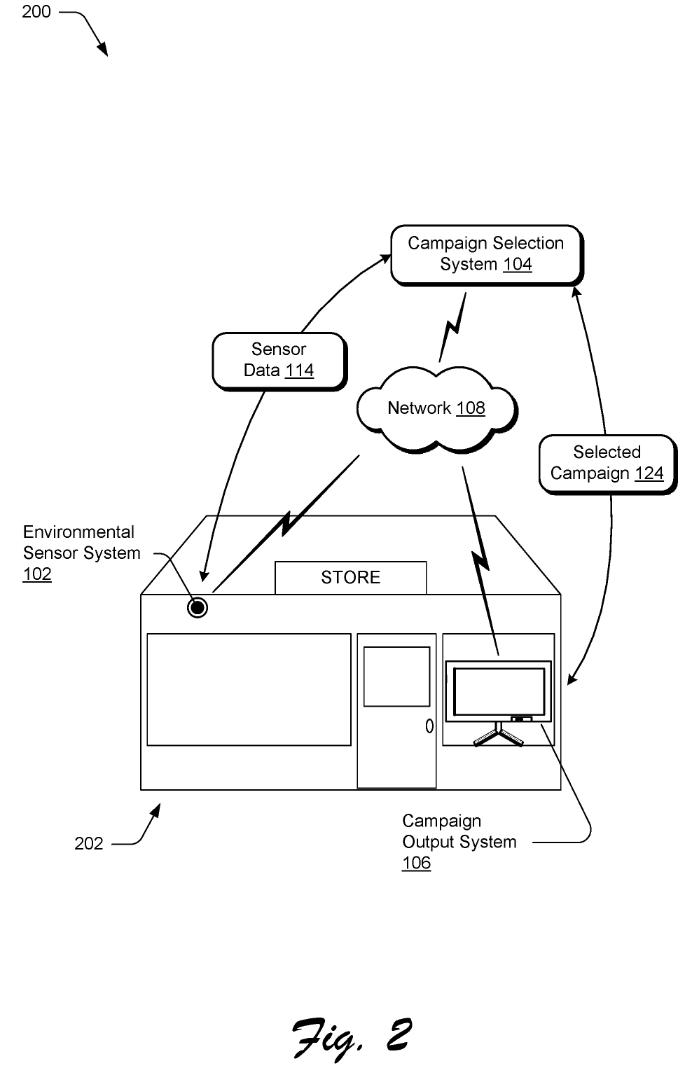

FIG. 2 depicts an example implementation, generally at 200, showing the digital environment of FIG. 1 implemented at a physical store 202. The environmental sensor system 102 is shown as being disposed outside of the store 202 and is able to communicate data indicative of an environmental condition of a physical environment outside of the store 202. An example of data indicative of the environmental condition of the physical environment outside of the store 202 is weather data (temperature, pressure, rain, etc.) detected by the environmental sensor system 102. The environmental sensor system 102 communicates sensor data 114 indicative of the environmental condition of the physical environment outside of the store 202 to the campaign selection system 104. In this example, campaign selection system 104 is remote to the store, i.e. not within the store, and connected to the environmental sensor system 102 via a network connection such as the internet. As discussed above, campaign selection system 104 may also be disposed within the store as an application running on a computing device, as part of the campaign output system 106, and so on. The campaign selection system 104 selects the selected campaign 124 based on the received sensor data 114 received from the environmental sensor system 102. The campaign selection system 104 then sends the selected campaign 124 to the campaign output system 106. In this example, the campaign output system 106 is illustrated as a monitor, such as an AEM® screen, disposed in a front window of the store 202.

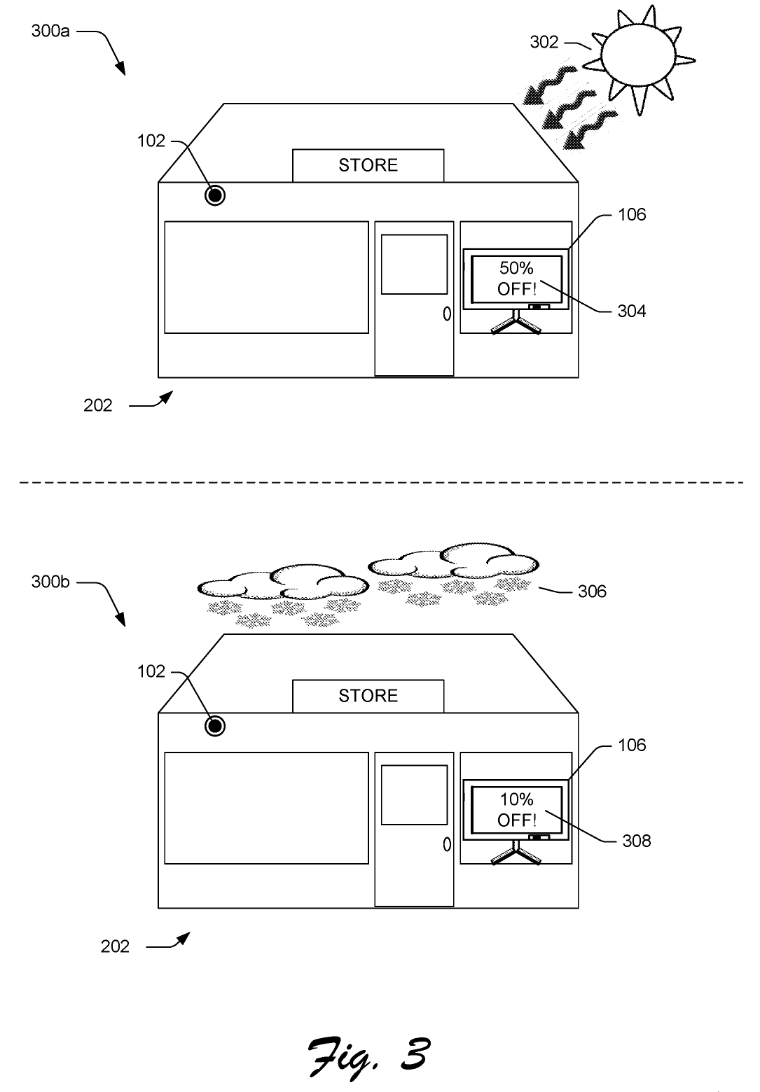

FIG. 3 depicts an example implementation, generally at 300, showing results of two example weather scenarios in the example implementation of FIG. 2. Weather scenario 300a shows the store 202 in a sunny environment 302 where the environmental sensor system 102 detects a warm temperature the physical environment of the store. The campaign selection system 104 (not shown) receives data indicating the warm temperature from the environmental sensor system 102 and selects a marketing campaign comprising a certain discount 304. The campaign selection system 104 then sends the marketing campaign 304 to the campaign output system 106 for display.

Weather scenario 300b shows the store 202 in a snowy environment 306 where environmental sensor system 102 detects a cold temperature of the physical environment of the store. The campaign selection system 104 (not shown) receives data indicative of the cold temperature from the environmental sensor system 102 and selects another marketing campaign comprising a certain discount 308 that is lower than the discount selected in scenario 300a. As shown, the switch from the marketing campaign in scenario 300a to the other marketing campaign in scenario 300b may merely comprise a change in percentage discount. Although not shown but discussed above, the other marketing campaign for scenario 300b may also be a completely different campaign, i.e. for a different product or service than for scenario 300a. The campaign selection system 104 then sends the other marketing campaign 308 comprising a certain discount that is lower than the discount chosen in scenario 300a for display by the campaign display device 106.

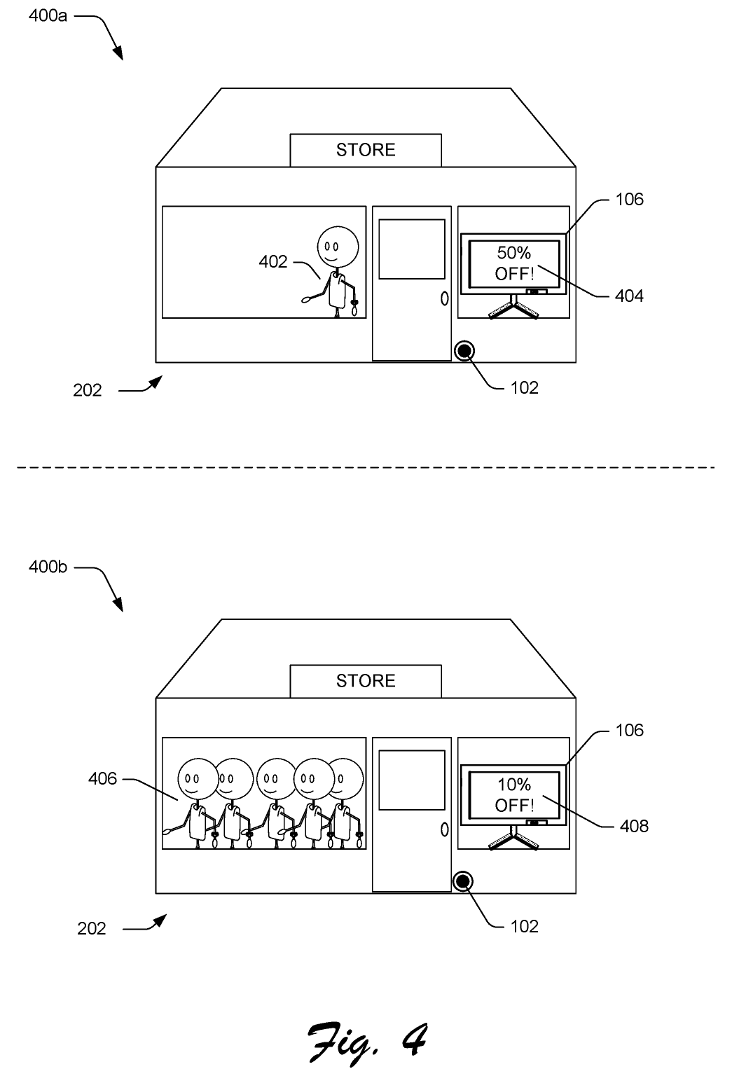

FIG. 4 depicts an example implementation, generally at 400, showing results of two customer population scenarios similar to the example implementation of FIG. 2. In this example, however, the environmental sensor system 102 is configured as a population monitoring device able to detect a number of customers in the store, i.e. door sensor, motion sensor, light curtain, etc. For example, the population monitoring device may comprise a door mounted sensor that is able to track customers entering and exiting the store. In another example, the population monitoring device may monitor an amount of movement in the store as a way to determine a number of people in the store. Population scenario 400a shows the store 202 with a single customer 402. The campaign selection system 104 (not shown) receives data indicative of the single customer 402 from the environmental sensor system 102 and selects a marketing campaign 404 comprising a certain discount. As shown, the switch from the marketing campaign in scenario 400a to the other marketing campaign in scenario 400b may merely comprise a change in percentage discount. Although not shown, but discussed above, the other marketing campaign for scenario 400b may also be a completely different campaign, i.e. for a different product or service than for scenario 400a. The campaign selection system 104 then sends the marketing campaign 404 to the campaign output system 106 for display.

Population scenario 400b shows the store 202 with many customers 404. The campaign selection system 104 (not shown) receives data indicative of the many customers 406 from the environmental sensor system 102 and selects another marketing campaign 408 comprising a certain discount that is less than the discount selected in scenario 400a. The campaign selection system 104 then sends the other marketing campaign 408 to the campaign display device 106 for display.

Through use of the techniques described herein, marketing campaigns can be selected and exposed to customers that align with physical environments in or around a physical store. This ensures that customers of the store are not being exposed to arbitrary marketing campaigns, but rather marketing campaigns that best coincide with their attitudes and desires as the physical environments change.

Example Procedures

The following discussion describes marketing campaign selection using local environmental sensors to detect an environmental condition of a physical environment of a physical store that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

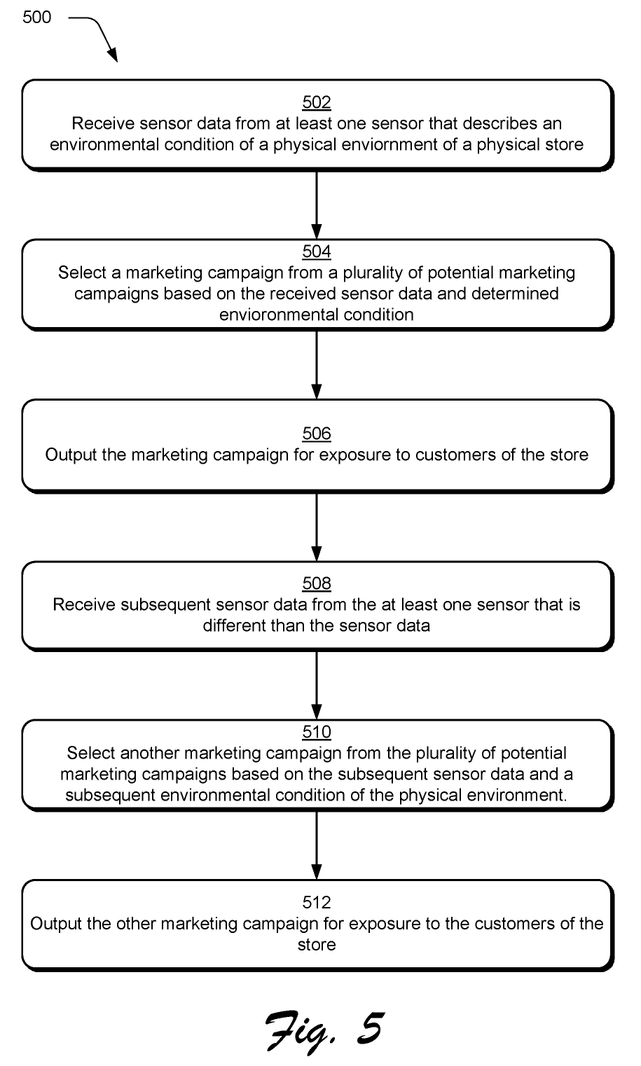

FIG. 5 depicts, generally at 500, a procedure in an example implementation in which marketing campaigns are selected based upon data received from environmental sensors that describes an environmental condition of a physical environment of a physical store.

First, sensor data is received from at least one environmental sensor disposed within or proximal to a physical store (step 502) that describes an environmental condition of a physical environment of a physical store. The environmental sensor may comprise a temperature sensor, a pressure sensor, a rain sensor, a wind sensor, a population monitoring device, a motion sensor, a light gate sensor, and so on. Using the above example sensors, the environmental condition may comprise a temperature, a pressure, presence of rain, presence of wind, or presence of people in or around the store.

Second, a marketing campaign is selected from a plurality of potential marketing campaigns based on the received sensor data and the determined environmental condition (step 504). As discussed above, the environmental condition may be determined from raw data received from the environmental sensor, e.g., raw output values that are then processed to detect the environmental condition, or by receiving the detected environmental condition from the environmental sensor after processing by the environmental sensor. For example, if the received sensor data indicates that the environment around the store is rain, a marketing campaign associated with umbrellas may be selected.

Third, the selected marketing campaign is output for exposure to customers of the store (step 506). The selected marketing campaign may be sent to customers directly as in an email or application notification or indirectly as in displayed on a monitor at the store, on a billboard, on a website associated with the store, and so on.

Fourth, subsequent sensor data is received from the sensor that describes a subsequent environmental condition of the physical environment of the physical store (step 508). The subsequent sensor data is different from the sensor data received at step 502. For example, the subsequent sensor data may indicate no rain or a rise in temperature from step 502.

Fifth, another marketing campaign is selected from the plurality of potential marketing campaigns based on the subsequent sensor data received and the subsequent environmental condition (step 510). For example, if the subsequent sensor data indicates that the subsequent environmental condition around the store is sunny and warm, a marketing campaign for sunscreen or beach towels may be selected. Another example is if the subsequent environmental condition around the store is warmer than the environmental condition in steps 502 and 504, a marketing campaign with a more aggressive sale may be selected.

Sixth, the selected other marketing campaign is output for exposure to customers of the store (step 512), for example, on an electronic billboard. In this way, as the environment around the store changes, so does a marketing campaign exposed to customers.

Example System and Device

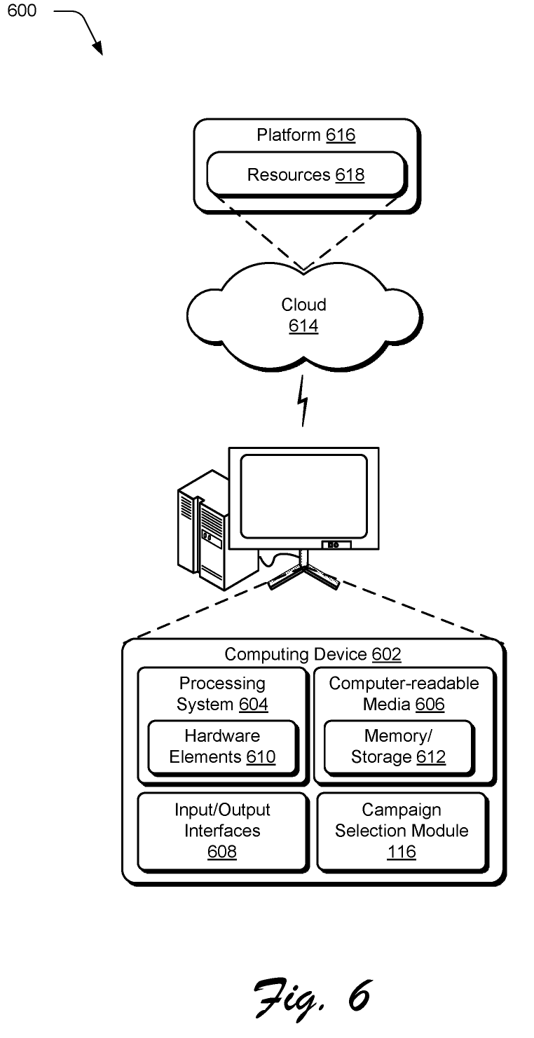

FIG. 6 depicts, generally at 600, an example implementation showing an example computing device 602 that is representative of one or more computing systems and/or devices that may implement the various techniques described herein. This is illustrated through inclusion of the portion sending module 116, which may be configured to cause a display of a portion of the document on a connected display device. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and nonvolatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device implementation, implementation of functionality described herein may be distributed throughout the system 600. For example, the functionality may be implemented in part on the computing device 602 as well as via the platform 616 that abstracts the functionality of the cloud 614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment in which data from at least one sensor is used to select a marketing campaign, a method comprising:
receiving, by at least one computing device, sensor data from the at least one sensor that describes an environmental condition of a physical environment in a vicinity of a physical store;
selecting, by the at least one computing device, the marketing campaign from a plurality of potential marketing campaigns based on the received sensor data and the environmental condition; and
outputting, by the at least one computing device, the selected marketing campaign for exposure to customers of the store.

2. The method as described in claim 1, wherein the outputting comprises sending, by the at least one computing device, the selected marketing campaign to at least one display device for exposure to the customers of the store.

3. The method as described in claim 1, wherein the outputting comprises sending, by the at least one computing device, an email or notification comprising the selected marketing campaign to the customers.

4. The method as described in claim 1, wherein the at least one sensor is proximal to the physical store.

5. The method as described in claim 1, wherein the at least one sensor is a temperature or weather sensor.

6. The method as described in claim 1, wherein the environmental condition is a number of customers in or around the physical store.

7. The method as described in claim 1, wherein the marketing campaign includes an offer for a discount for goods or services available from the physical store or a website of the physical store.

8. The method as described in claim 1, wherein the method further comprises:
receiving subsequent sensor data from the at least one sensor that is different than the received sensor data that describes a subsequent environmental condition of the physical environment in the vicinity of the physical store;
selecting, by the at least one computing device, another marketing campaign from the plurality of potential marking campaigns based on the received subsequent sensor data and the subsequent environmental condition; and
outputting, by the at least one computing device, the other selected marketing campaign for exposure to customers of the store.

9. The method as described in claim 8, wherein the selected marketing campaign is a first type of product or service associated with the environmental condition and the other selected marketing campaign is second type of product or service associated with the subsequent environmental condition that is different than the first type of product.

10. The method as described in claim 8, wherein the selecting the other marketing campaign occurs in real-time as the environmental condition changes to the subsequent environmental condition.

11. The method as described in claim 8, wherein the at least one sensor is a temperature sensor and the other selected marketing campaign comprises a larger discount than the selected marketing campaign responsive to an increase in temperature in the vicinity of the store.

12. A system comprising:
a means for exposing a marketing campaign to customers of a physical store or a website of the physical store;
at least one sensor disposed in a vicinity of the exposing means;
a means for selecting a marketing campaign configured to:
receive sensor data from the at least one sensor;
determine an environmental condition of a physical environment in the vicinity of the exposing means based on the received sensor data; and
select the marketing campaign from a plurality of potential marketing campaigns based on the determined environmental condition; and
a processing system configured to send the selected marketing campaign determined by the selecting means to the exposing means for exposure to the customers.

13. The system as described in claim 12, wherein the at least one sensor comprises a weather sensor, the determined environmental condition comprises a determined weather condition, and the selected marketing campaign is selected based on the determined weather condition.

14. The system as described in claim 12, wherein the at least one sensor comprises a population monitoring device able to detect an amount of people in the vicinity of the exposing means, the determined environmental condition comprises the amount of people in the vicinity of the exposing means, and the marketing campaign is selected based on the amount of people in the vicinity of the exposing means.

15. The system as described in claim 12, wherein the selection means is further configured to:
receive subsequent sensor data from the at least one sensor that is different than the sensor data;
determine another environmental condition of the physical environment in the vicinity of the exposing means based on the received subsequent sensor data; and
select another marketing campaign from the plurality of potential marketing campaigns; based on the other environmental condition; and
the exposing means is further configured to expose the selected other marketing campaign to the customers.

16. The system as described in claim 15, wherein the other environmental condition is determined based on a threshold value of the subsequent sensor data being met.

17. The system as described in claim 15, wherein the selecting the other marketing campaign occurs in real-time as the received sensor data changes to the received subsequent sensor data.

18. At least one computer-readable storage media device comprising instructions that, when executed by a processing system, cause the processing system to implement a marketing campaign selection module configured to:
receive sensor data from at least one environmental sensor disposed in a vicinity of a physical store; and
output a marketing campaign for exposure to customers, the marketing campaign selected from a plurality of potential marketing campaigns based on an environmental condition of a physical environment in the vicinity of the physical store determined from the received sensor data.

19. The at least one computer-readable storage media device as described in claim 18, wherein the marketing campaign selection module is further configured to:
receive subsequent sensor data from the at least one environmental sensor; and
output another marketing campaign selected from the plurality of potential marketing campaigns based on another environmental condition in the vicinity of the physical environment of the physical store determined in real-time from the received subsequent sensor data.

20. The at least one computer-readable storage media device as described in claim 18, wherein the at least one sensor comprises a weather sensor, the received sensor data comprises weather data, and the selected marketing campaign is selected based on the weather data.
